(19) United States
(12) Patent Application Publication
(10) Pub. No.: US 2026/0057349 A1
(43) Pub. Date: Feb. 26, 2026

(54) SCHEDULE OPTIMIZATION FRAMEWORK

(71) Applicant: Julianna Piechoczek, Atlanta, GA (US)

(72) Inventor: Julianna Piechoczek, Atlanta, GA (US)

(21) Appl. No.: 18/811,227

(22) Filed: Aug. 21, 2024

(51) Int. Cl. G06Q 10/1093; G06Q 10/04

(52) U.S. Cl. CPC G06Q 10/1093; G06Q 10/04

(57) ABSTRACT

Various embodiments provide systems, apparatuses, methods, and computer program products for schedule optimization. In an example embodiment, a computer-implemented method comprises receiving an indication of a schedule modification request associated with a client entity, identifying a client document comprising a plurality of linked entity identifiers, generating, using a scheduling optimization model, a predictive candidate entity dataset based on the client document and input dataset corresponding to the client document, wherein the predictive candidate entity dataset comprises one or more ranked candidate linked entity identifiers from the plurality of linked entity identifiers and corresponding ranking, and initiating performance of one or more prediction-based actions based on the predictive candidate entity dataset.

### TECHNOLOGICAL FIELD

The present disclosure relates to schedule optimization. Example embodiments are directed to schedule optimization framework.

### BACKGROUND

Various embodiments of the present disclosure address technical challenges related to schedule optimization. Through applied effort, ingenuity, and innovation, Applicant has solved problems related to schedule optimization by developing solutions embodied in the present disclosure, which are described in detail below.

### BRIEF SUMMARY

In general, embodiments of the present disclosure provide systems, apparatuses, methods, and computer program products for schedule optimization.

In accordance with an aspect of the present disclosure, a computer-implemented method is provided. In an example embodiment, the computer-implemented method comprises receiving, by one or more processors, an indication of a schedule modification request associated with a client entity; identifying, by the one or more processors, a client document comprising a plurality of linked entity identifiers; generating, by the one or more processors and using a scheduling optimization model, a predictive candidate entity dataset based on the client document and input dataset corresponding to the client document, wherein the predictive candidate entity dataset comprises one or more ranked candidate linked entity identifiers from the plurality of linked entity identifiers and corresponding ranking; and initiating performance of one or more prediction-based actions based on the predictive candidate entity dataset.

In some embodiments, initiating the performance of the one or more prediction-based actions comprises selecting a first candidate linked entity identifier from the predictive candidate entity dataset based on the corresponding ranking; generating a message data object based on the first candidate linked entity identifier selected; and transmitting the message data object to a first user device associated with the first candidate linked entity identifier selected.

In some embodiments, the computer-implemented method further comprises receiving an indication of an acceptance notification from the first user device; and updating the client document based on the acceptance notification.

In some embodiments, the computer-implemented method further comprising receiving an indication of a rejection notification from the first user device; selecting a second candidate linked entity identifier from the predictive candidate entity dataset based on the corresponding ranking; and transmitting a second message data object to a second user device associated with the second candidate linked entity identifier.

In some embodiments, the input dataset comprises current location data associated with one or more linked entity identifiers.

In some embodiments, the computer-implemented method further comprises for each of the one or more linked entity identifiers, receiving location data associated with the linked entity identifier via one or more location sensing devices.

In some embodiments, the input dataset comprises availability data associated with one or more linked entity identifiers.

In some embodiments, the scheduling optimization model is a machine learning model.

In accordance with another aspect of the present disclosure, a computing system is provided. In an example embodiment, the computing system comprises memory and one or more processors communicatively coupled to the memory, the one or more processors configured to receive an indication of a schedule modification request associated with a client entity; identify a client document comprising a plurality of linked entity identifiers; generate, using a scheduling optimization model, a predictive candidate entity dataset based on the client document and input dataset corresponding to the client document, wherein the predictive candidate entity dataset comprises one or more ranked candidate linked entity identifiers from the plurality of linked entity identifiers and corresponding ranking; and initiate performance of one or more prediction-based actions based on the predictive candidate entity dataset.

In some embodiments, the one or more processors are configured to initiate the performance of the one or more prediction-based actions by selecting a first candidate linked entity identifier from the predictive candidate entity dataset based on the corresponding ranking; generating a message data object based on the first candidate linked entity identifier selected; and transmitting the message data object to a first user device associated with the first candidate linked entity identifier selected.

In some embodiments, the one or more processors are further configured to receive an indication of an acceptance notification from the first user device; and update the client document based on the acceptance notification.

In some embodiments, the one or more processors are further configured to receive an indication of a rejection notification from the first user device; select a second candidate linked entity identifier from the predictive candidate entity dataset based on the corresponding ranking; and transmit a second message data object to a second user device associated with the second candidate linked entity identifier.

In some embodiments, the input dataset comprises current location data associated with one or more linked entity identifiers.

In some embodiments, the one or more processors are further configured to for each of the one or more linked entity identifiers, receive location data associated with the linked entity identifier via one or more location sensing devices.

In some embodiments, the input dataset comprises availability data associated with one or more linked entity identifiers.

In some embodiments, the scheduling optimization model is a machine learning model.

In accordance with another aspect of the present disclosure, a computer implemented method is provided. In some embodiments, the computer-implemented method comprises receiving, by one or more processors, an indication of a schedule request associated with a set of predictive entities; generating, by the one or more processors, a predictive candidate schedule dataset based on an input dataset associated with the set of predictive entities, wherein the predictive candidate schedule dataset comprises candidate time windows; providing, by the one or more processors, the predictive candidate schedule dataset to the set of predictive entities; in response to receiving user inputs, selecting, by the one or more processors, an optimal time window from the candidate time windows based at least in part on the user inputs, wherein the user inputs comprises ranked predictive candidate schedule datasets; and providing data including the optimal time window to user devices associated with the set of predictive entities.

In some embodiments, the computer-implemented method further comprises identifying the input dataset.

In some embodiments, the input dataset comprises an electronic calendar associated with each predictive entity in the set of predictive entities.

In some embodiments, generating the predictive candidate schedule dataset comprises applying the input dataset to a scheduling optimization model.

### BRIEF DESCRIPTION OF THE DRAWINGS

FIG. 1 provides an example overview of an architecture in accordance with some embodiments of the present disclosure.

FIG. 2 provides an example predictive computing entity in accordance with some embodiments of the present disclosure.

FIG. 3 provides an example user device in accordance with some embodiments of the present disclosure.

FIG. 4 is a dataflow diagram for schedule optimization framework in accordance with some embodiments of the present disclosure.

FIG. 5 is a dataflow diagram for schedule optimization framework in accordance with some embodiments of the present disclosure.

FIG. 6 is a flowchart diagram of an example process for implementing a schedule optimization framework in accordance with some embodiments of the present disclosure.

FIG. 7 is a flowchart diagram of an example process for implementing a schedule optimization framework in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

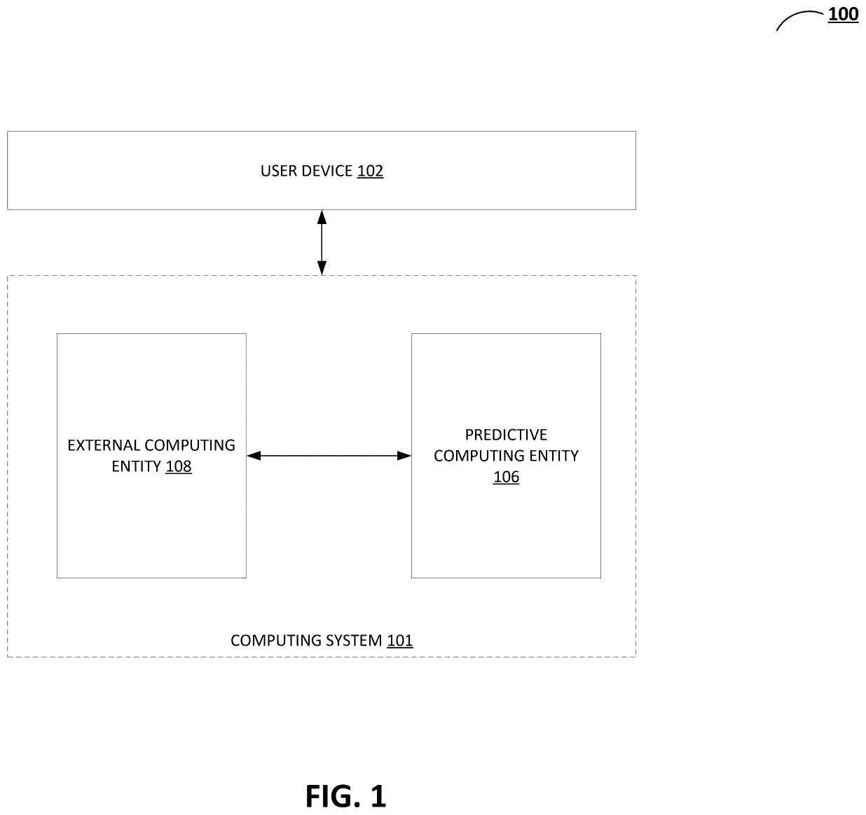

FIG. 1 provides an example overview of an architecture 100 in accordance with some embodiments of the present disclosure. The architecture 100 includes a computing system 101 configured to receive indication of a request such as a scheduling modification requests and/or scheduling request, process the request to generate predictive outputs (e.g., predictive candidate entity data set, scheduling plan, or the like), and initiate performance of one or more prediction-based actions based on the predictive output. The example architecture 100 may be used in a plurality of domains and not limited to any specific application as disclosed herewith. The plurality of domains may include banking, healthcare, industrial, manufacturing, education, retail, to name a few.

In some embodiments, the computing system 101 may communicate with at least one of user devices 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive indication of a scheduling modification request and/or a scheduling request, process the scheduling modification request and/or scheduling request to generate predictive outputs, such as predictive candidate entity dataset, message data objects, scheduling plan and/or the like, and initiate the performance of one or more prediction-based actions.

The predictive computing entity 106 and/or one or more external computing entities 108 may comprise storage subsystems that may be configured to store input data (e.g., performance data such as reference datasets, predictive candidate entity dataset, scheduling plan, or the like), training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and/or evaluate scheduling optimization models in accordance with one or more training and/or inference operations of the present disclosure. In some examples, the external computing entities 108 may be configured to train, implement, use, update, and/or evaluate scheduling optimization models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., scheduling optimization techniques, and/or the like) described herein. The external computing entities 108, for example, may include and/or be associated with one or more entities that may be configured to receive, transmit, store, manage, and/or facilitate datasets, such as client documents, and/or the like. The external computing entities 108, for example, may include data sources that may provide such datasets to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

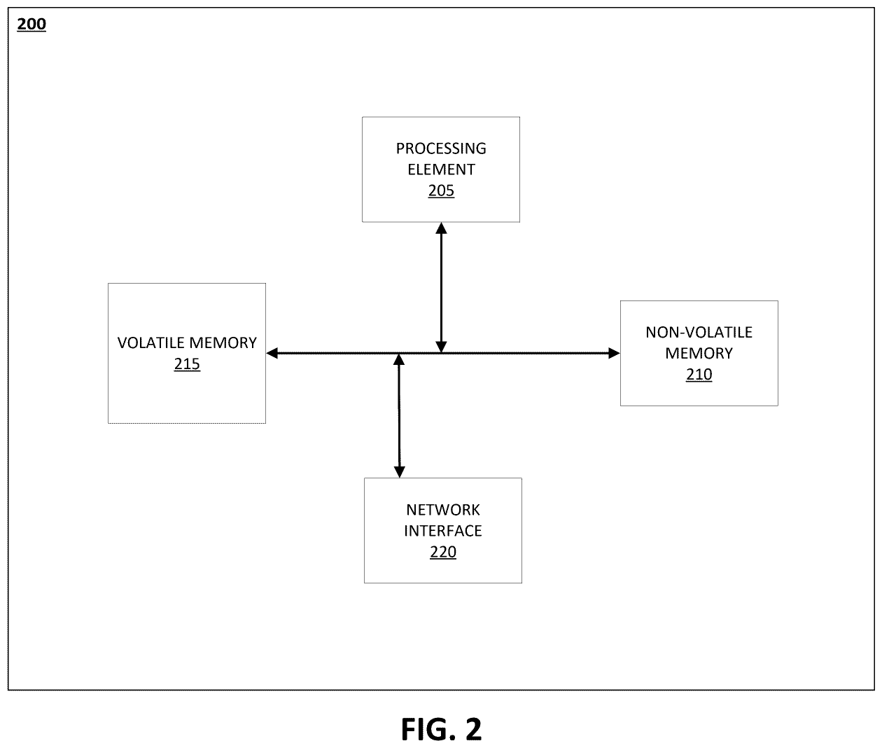

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more scheduling optimization models, monitoring, evaluating, comparing, and/or similar terms used herein. In some embodiments, these functions, operations, and/or processes may be performed on data, content, information, and/or similar terms used herein interchangeably. In some embodiments, one computing entity (e.g., predictive computing entity 106, etc.) may train and use one or more scheduling optimization models described herein. In other embodiments, a first computing entity (e.g., predictive computing entity 106, etc.) may use one or more scheduling optimization models that may be trained by a second computing entity (e.g., external computing entity 108) communicatively coupled to the first computing entity. The second computing entity, for example, may train one or more of the scheduling optimization models described herein, and subsequently provide the scheduling optimization model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more scheduling optimization models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more scheduling optimization models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more scheduling optimization models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the user device 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more scheduling optimization models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example User Device

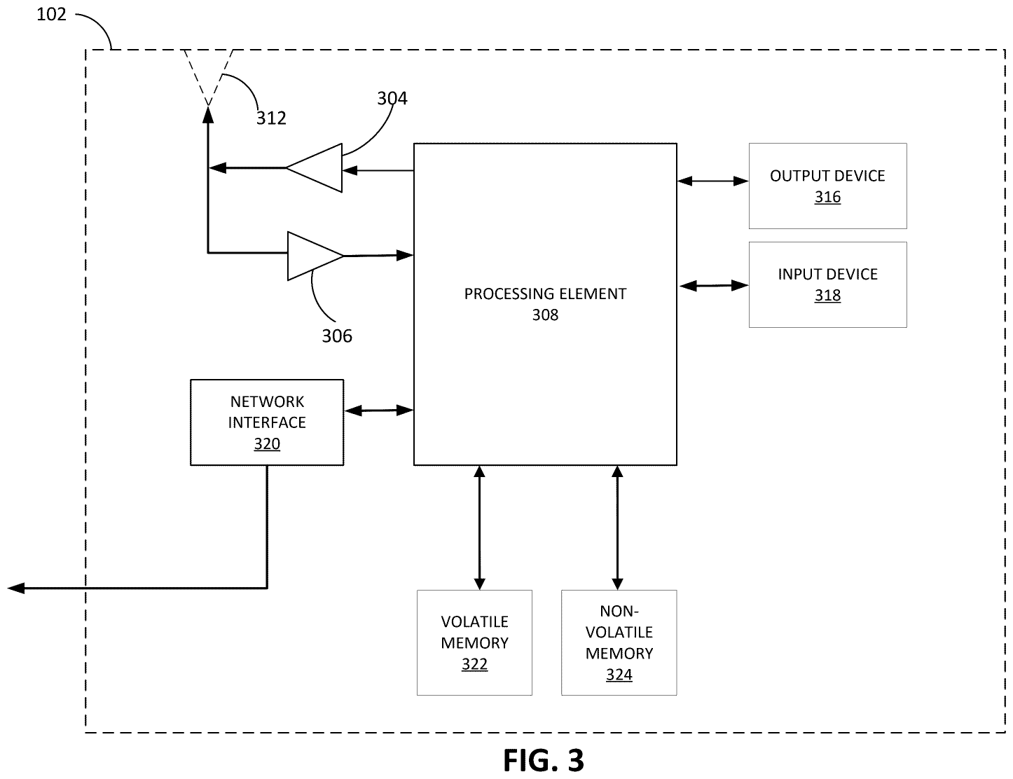

FIG. 3 provides an example user device in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User devices 102 may be operated by various parties. As shown in FIG. 3, the user device 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the user device 102 may be capable of operating with one or more air interface standards, communication protocols, modulation types, and access types. More particularly, the user device 102 may operate in accordance with any of a number of wireless communication standards and protocols, such as those described above with regard to the computing entity 200. In some embodiments, the user device 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user device 102 may operate in accordance with multiple wired communication standards and protocols, such as those described above with regard to the computing entity 200 via a network interface 320.

Via these communication standards and protocols, the user device 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user device 102 may also download code, changes, add-ons, and updates, for instance, to its firmware, software (e.g., including executable instructions, applications, program modules), and operating system.

According to some embodiments, the user device 102 may include location determining aspects, devices, modules, functionalities, and/or similar words used herein interchangeably. For example, the user device 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the user device 102 in connection with a variety of other systems, including cellular towers, Wi-Fi access points, and/or the like. Similarly, the user device 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The user device 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the user device 102 to interact with and/or cause display of information/data from the computing entity 200, as described herein. The user input interface may comprise any of a plurality of input devices 318 (or interfaces) allowing the user device 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the user device 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The user device 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the user device 102. As indicated, this may include a user application that is resident on the user device 102 or accessible through a browser or other user interface for communicating with the computing entity 200 and/or various other computing entities.

In another embodiment, the user device 102 may include one or more components or functionalities that are the same or similar to those of the computing entity 200, as described in greater detail above. In one such embodiment, the user device 102 downloads, e.g., via network interface 320, code embodying machine learning model(s) from the computing entity 200 so that the user device 102 may run a local instance of the machine learning model(s). As will be recognized, these architectures and descriptions are provided for example purposes only and are not limited to the various embodiments.

In various embodiments, the user device 102 may be embodied as an artificial intelligence (AI) computing entity, such as an Amazon Echo, Amazon Echo Dot, Amazon Show, Google Home, and/or the like. Accordingly, the user device 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Definitions

In some embodiments, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network. ” Similarly, where a computing entity is described herein to send data to another computing entity, it will be appreciated that the data may be sent directly to another computing entity or may be sent indirectly via one or more intermediary computing entities, such as, for example, one or more servers, relays, routers, network access points, base stations, hosts, and/or the like.

In some embodiments, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

In some embodiments, the term “computer-readable storage medium,” refers to a physical storage medium (e.g., volatile, or non-volatile memory device), and may be differentiated from a “computer-readable transmission medium,” which refers to an electromagnetic signal.

In some embodiments, the terms “data structure,” “data object,” or “data set” refer interchangeably to data capable of being transmitted, received, and/or stored.

As used herein, the term “machine learning model” refers to one or more processes, algorithms, and/or other data entity that describes parameters, hyper-parameters, defined operations, and/or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, support vector machines, gradient boosts, Markov models, adaptive Bayesian techniques, and statistical models (e.g., timeseries-based forecast models such as autoregressive models, autoregressive moving average models, and/or an autoregressive integrating moving average models). Additionally, and without limitation, an MDA, as used in the singular, may include ensembles using multiple machine learning and/or statistical techniques.

In some embodiments, the term “client entity” refers to an entity that may be associated with one or more linked entities. A client entity may be configured to provide services to linked entities. Non-limiting examples of a client entity include a medical service provider such as a medical clinic, a medical laboratory, or the like; a salon, a plumbing service provider, a heating, ventilation, and air conditioning (HVAC) service provider, or the like. A client entity may be associated with a schedule that includes a scheduled event for one or more linked entities.

In some embodiments, the term “scheduled event” refers to a scheduled service for a linked entity. An example of a scheduled event is a scheduled medical visit for a patient of a medical clinic. Another example of a scheduled event is a scheduled visit for a customer of a business (e.g., restaurant, salon, or the like). A scheduled event may be associated with a time window for which the service is scheduled to be provided to the linked entity.

In some embodiments, the terms “schedule modification request indication” and “schedule request indication” refer to any signals, data, instructions, and/or the like configured to trigger or otherwise initiate a scheduling optimization process. In some embodiments, a schedule modification request indication may originate from a user device. As an example, a scheduling modification request indication may be generated in response to cancelation of a scheduled event by a linked entity.

In some embodiments, the term “linked entity” refers to an entity associated with a client entity. A linked entity, for example, may include a patient of a medical clinic, a customer of a salon, or the like. In some embodiments, a linked entity may be associated with a linked entity identifier.

In some embodiments, the term “client document” refers to a data entity that describes a collection of units of text leveraged to identify candidate linked entities for a scheduling task. A client document, for example, may include linked entity identifiers associated with linked entities of a client entity. A client document may be input to a scheduling optimization model along with a corresponding input dataset. As one example, a client document may include a waiting list for a client entity. For example, in a healthcare domain, a client document may include a waiting list for a medical service provider such as a medical clinic. As another example, in an industrial domain, a client document may include a waiting for a heating, an HVAC service provider, or the like. As yet another example, in a business domain, a client document may include a waiting list for a restaurant, a salon, or the like.

In some embodiments, the term “linked entity identifier” refers to one or more items of data by which a linked entity may be uniquely identified from other linked entities. In some embodiments, a linked entity identifier may comprise ASCII text, a pointer, a memory address, and/or other data that uniquely identifies a particular linked entity.

In some embodiments, the term “linked entity data” refers to data associated with a linked entity. Non-limiting examples of linked entity data include linked entity identifier, linked entity address, linked entity name, linked entity preferences, and/or the like.

In some embodiments, the term “scheduling optimization model” refers to one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to generate or facilitate generation of predictive candidate entity dataset and related predictions, data, and other outputs. A scheduling optimization model may include artificial intelligence algorithms and techniques, including machine learning. In some embodiments, a scheduling optimization model may be configured, trained, and/or the like to generate predictive candidate entity datasets based at least in part on a client document associated with the client entity and corresponding input dataset. Alternatively or additionally, in some embodiments, a scheduling optimization model may be configured, trained, and/or the like to generate a predictive candidate schedule datasets based at least in part on an input dataset. In some examples, a scheduling optimization model may include multiple models configured to perform one or more stages of a scheduling task A scheduling optimization model may include one or more of any type of machine learning models including one or more supervised, unsupervised, semi-supervised, reinforcement learning models, and/or the like. In some examples, a scheduling optimization model of one or more scheduling optimization models includes a generative artificial intelligence model, an artificial neutral network, or the like.

In some embodiments, the term “message data object” refers to a type of data object that includes a message configured to be transmitted between entities. Non-limiting examples of a message data object include text messages, SMS messages, electronic mail (email), social media post, post mail, phone communication, or the like. In some embodiments, the message data object may include a notification, invitation, or the like to associate a linked entity with a scheduled event (e.g., previously associated with another linked entity). For example, in the healthcare domain, a message data object may include a notification to a patient that a medical visit time slot as opened up and the patient is invited to take the open timeslot.

In some embodiments, the term “predictive candidate entity dataset” refers to output of a scheduling optimization model. In some embodiments, the predictive candidate entity dataset comprises ranked candidate linked entity identifiers. In some embodiments, the predictive candidate entity dataset comprises candidate time windows.

In some embodiments, the term “ranked candidate linked entity identifier” is a linked entity identifier that is ranked with respect to other linked entity identifiers based at least in part on the input dataset associated with each linked entity identifier. In some embodiments, a ranking associated with a candidate linked entity identifier may reflect an estimated likelihood of the linked entity associated with the linked entity identifier making it to a scheduled event previously associated with another linked entity (e.g., an event such as a medical visit previously scheduled for another patient). For example, a ranked candidate linked entity identifier may be identified using scheduling optimization techniques described herein as having one or more estimated likelihoods of making it to the scheduled event that satisfies a threshold and ranked based on the estimated likelihood.

### IV. Overview

The present disclosure relates to performing schedule optimization for entities such as client entities and/or predictive entities. Example embodiments may receive an indication of a schedule modification request associated with a client entity, identify a client document associated with the client entity, and generate using a scheduling optimization model, a predictive candidate entity dataset based on the client document and input dataset corresponding to the client document. For example, the client document may comprise a plurality of linked entity identifiers. A non-limiting example of a client document is a waiting list of a business, where the waiting list comprises at least names of customers of the business.

In some embodiments, the input dataset may comprise current location data associated with one or more linked entity identifiers. Example embodiments may receive location data associated with a linked entity identifier via one or more location sensing devices. In some embodiments, alternatively or additionally, the input dataset comprises availability data associated with one or more linked entity identifiers.

In some embodiments, the predictive candidate entity dataset generated by the system described herein may comprise one or more ranked candidate linked entity identifiers from the plurality of linked entity identifiers along with the corresponding ranking.

Example embodiments may select a candidate linked entity identifier from the predictive candidate entity dataset based on the corresponding ranking, generate a message data object based on the candidate linked entity identifier selected, and transmits the message data object to a user device associated with the candidate linked entity identifier selected. In some embodiments, the scheduling optimization model is a machine learning model.

Example embodiments may receive an indication of a schedule request associated with a set of predictive entities, generate a predictive candidate schedule dataset based on an input dataset associated with the set of predictive entities, and provide the predictive candidate schedule dataset to the set of predictive entities. The predictive candidate schedule dataset may comprise candidate time windows. Example embodiments, in response to receiving user inputs, may select an optimal time window from the candidate time windows based at least in part on the user inputs. In some embodiments, the user inputs may comprise ranked predictive candidate schedule datasets (e.g., a ranking of the candidate time widows, individually, by the predictive entities). In some embodiments, the input dataset may comprise an electronic calendar associated with each predictive entity in the set of predictive entities. Example embodiments may provide the optimal time window to user devices associated with the set of predictive entities.

Various technical improvements will be appreciated from the present disclosure. For example, example embodiments of the present disclosure leverage location data to determine the proximity of linked entities (e.g., customers of businesses, or the like) to identify linked entities that can take a service time slot of a client entity (e.g., a business such as a restaurant, a medical clinic, or the) that was previously associated with another linked entity. In this regard, example embodiments of the present disclosure improves operating efficiency and optimizes resource usage.

### V. Example System Operations

As indicated, various embodiments of the present disclosure make important technical contributions to performance analysis modelling techniques. In particular, systems and methods are disclosed herein that implement a multi-layer technique configured to ingest performance data at a client entity level or at sub-increment levels of the client entity, and performance insights to be generated at the various levels. By doing so, the techniques of the present disclosure improve the technological field of performance data analysis.

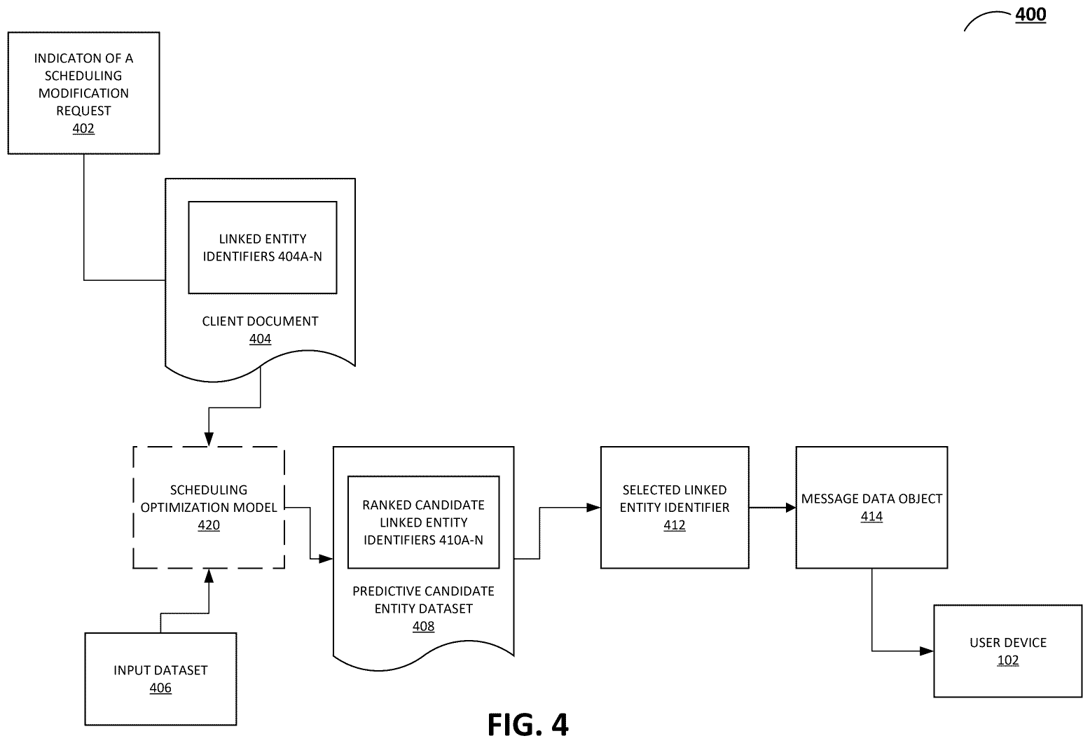

FIG. 4 provides a dataflow diagram 400 for a schedule optimization framework in accordance with some embodiments discussed herein. Specifically FIG. 4 provides a data flow diagram for a schedule optimization framework initiated based on a schedule modification request. In some embodiments, an indication of a schedule modification request 402 associated with a client entity is received.

In some embodiments, the schedule modification request indication is any signals, data, instructions, and/or the like configured to trigger or otherwise initiate a scheduling optimization process. In some embodiments, a schedule modification request indication may originate from a user device. As an example, a scheduling modification request indication may be generated in response to cancelation of a scheduled event by a linked entity. For example, the indication of the schedule modification request 402 may be received in response to cancelation of a scheduled event by a linked entity associated with the client entity.

In some embodiments, the client entity is an entity that may be associated with one or more linked entities. A client entity may be configured to provide services to the linked entities. Non-limiting examples of a client entity include a medical service provider such as a medical clinic, a medical laboratory, or the like; a salon, a plumbing service provider, a heating, ventilation, and air conditioning (HVAC) service provider, or the like. A client entity may be associated with a schedule that includes a scheduled event for one or more linked entities.

In some embodiments, the scheduled event is a scheduled service for a linked entity. An example of a scheduled event is a scheduled medical visit for a patient of a medical clinic. Another example of a scheduled event is a scheduled visit for a customer of a business (e.g., restaurant, salon, or the like). A scheduled event may be associated with a time window for which the service is scheduled to be provided to the linked entity.

In some embodiments, a linked entity is an entity associated with a client entity. A linked entity, for example, may include a patient of a medical clinic, a customer of a restaurant, a customer of a salon, or the like. In some embodiments, a linked entity may be associated with a linked entity identifier.

In some embodiments, the linked entity identifier is one or more items of data by which a linked entity may be uniquely identified from other linked entities. In some embodiments, a linked entity identifier may comprise ASCII text, a pointer, a memory address, and/or other data that uniquely identifies a particular linked entity.

In some embodiments, a client document 404 comprising a plurality of linked entity identifiers is identified.

In some embodiments, the client document 404 is to a data entity that describes a collection of units of text leveraged to identify candidate linked entities for a scheduling task. The client document, 404 for example, may include linked entity identifiers associated with linked entities of a client entity. The client document 404 may be input to a scheduling optimization model along with a corresponding input dataset. As one example, a client document may include a waiting list for a client entity. For example, in a healthcare domain, a client document may include a waiting list for a medical service provider such as a medical clinic. As another example, in an industrial domain, a client document may include a waiting for a heating, an HVAC service provider, or the like. As yet another example, in a business domain, a client document may include a waiting list for a restaurant, a salon, or the like.

In some embodiments, a predictive candidate entity dataset 408 is generated using a scheduling optimization model 420 and based on the client document 404 and input dataset 406 corresponding to the client document 404. In some embodiments, the predictive candidate entity dataset 408 comprises one or more ranked candidate linked entity identifiers 410A-N from the plurality of linked entity identifiers 404A-N along with corresponding ranking. For example, the client document 404 and the input dataset 406 may be applied to a scheduling optimization model 420 configured to analyze the client document 404 with respect to the input dataset 406, rank at least a subset of the linked entity identifiers 404A-N in the client document 404, and output the predictive candidate entity dataset 408 comprising the ranked candidate linked entity identifiers 410A-N along with their corresponding ranking.

In some embodiments, a ranked candidate linked entity identifier is a linked entity identifier that is ranked with respect to other linked entity identifiers based at least in part on the input dataset 406 associated with each linked entity identifier. In some embodiments, a ranking associated with a candidate linked entity identifier may reflect an estimated likelihood of the linked entity associated with the linked entity identifier making it to a scheduled event previously associated with another linked entity (e.g., an event such as a medical visit previously scheduled for another patient). For example, a ranked candidate linked entity identifier may be identified using scheduling optimization techniques described herein as having one or more estimated likelihoods of making it to the scheduled event that satisfies a threshold and ranked based on the estimated likelihood.

In some embodiments, the input dataset comprises current location data associated with one or more linked entity identifiers. For example, for each of the one or more linked entity identifiers, current location data associated with the linked entity identifier may be received via one or more location sensing devices (e.g., GPS, location tracking devices, or the like). The current location data associated with a linked entity may be leveraged by the scheduling optimization model 420 to determine the proximity of the linked entity to a location associated with the scheduled event (e.g., location, where a service is to be provided such as medical clinic location, a restaurant location, or the like). For example, the scheduling optimization model 420 may determine, based on the proximity of the linked entity to the schedule event location, the likelihood of the linked entity making it to the scheduled event at the time associated with the scheduled event. For example, if a linked entity is determined by the scheduling optimization model 420 based at least in part on the location data associated with the linked entity identifier that the corresponding linked entity has as an estimated likelihood of making it to the scheduled event at the associated time that satisfies a predetermined proximity-based likelihood threshold, the linked entity may be included in the predictive candidate entity dataset 408 otherwise the linked entity may not be included in the predictive candidate entity dataset 408.

Alternatively or additionally, the scheduling optimization model 420 may determine whether to include a linked entity identifier in the predictive candidate entity dataset 408 based on availability data associated with the client entity identifier. For example, the input dataset 406 may include availability for the linked entities based on a schedule for each linked entity that is accessible by the system 101 or otherwise received from the respective linked entity (e.g., in real-time or near real-time). For example, if a linked entity is determined by the scheduling optimization model 420 based at least in part on the availability data associated with the linked entity identifier that the corresponding linked entity has as an estimated likelihood of making it to the scheduled event at the associated time that satisfies a predetermined availability-based likelihood threshold, the linked entity may be included in the predictive candidate entity dataset 408 otherwise the linked entity may not be included in the predictive candidate entity dataset 408.

In this regard, the scheduling optimization model 420 may determine whether to include a linked entity identifier in the predictive candidate entity dataset 408 based on one or more of the current location data associated with the linked entity identifiers or the availability data for the linked entity identifiers. It would be appreciated that the input dataset 406 may comprise any data that may be leveraged by the scheduling optimization model to determine the likelihood of a linked entity making it to a schedule event at the time associated with the scheduled event.

In some embodiments, the scheduling optimization model 420 may select the linked entity identifiers determined to satisfy the proximity-based likelihood threshold and/or that satisfy the availability-based likelihood threshold as candidate linked entity identifiers. The scheduling optimization model 420 may rank the candidate linked entity identifiers based on one or more criteria such as the proximity of the corresponding linked entities to the scheduled event location, an initial ranking for the linked entities, or the like. For example, where the client document comprise a waiting list, an initial ranking for a linked entity identifier may correspond to the number associated with the linked entity identifier on the waiting list.

In some embodiments, performance of one or more prediction-based actions is initiated based on the predictive candidate entity dataset. In some embodiments, initiating the performance of the one or more prediction-based actions comprises selecting a first candidate linked entity identifier from the predictive candidate entity dataset based on the corresponding ranking, generating a message data object based on the first linked entity identifier selected, and transmitting a message data object 414 to a first user device 102 associated with the first candidate linked entity identifier selected. In some embodiments, the first candidate linked entity identifier selected may be a candidate linked entity identifier associated with a ranking in the top N ranking., where N is an integer (e.g., 1, 4, 10, or the like).

In some embodiments, the message data object 414 is a type of data object that includes a message configured to be transmitted between entities. Non-limiting examples of a message data object 414 include text messages, SMS messages, electronic mail (email), social media post, post mail, phone communication, or the like. In some embodiments, the message data object may include a notification, invitation, or the like to associate a linked entity with a scheduled event (e.g., previously associated with another linked entity). For example, in the healthcare domain, a message data object may include a notification to a patient that a medical visit time slot as opened up and the patient is invited to take the open timeslot.

In some embodiments, an indication of an acceptance notification with respect to the scheduled event may be received from the first user device 102. In some embodiments, in response to the indication of the acceptance notification, the client document may be updated. For example, where the client document comprise a waiting list, the linked entity associated with the first user device 102 may be removed from the client document. In some embodiments, an indication of a rejection notification with respect to the scheduled event may be received from the first user device 102. In some embodiments, in response to the indication of the rejection notification a second candidate linked entity identifier is selected from the predictive candidate entity dataset based on the corresponding ranking, and a second message data object is transmitted to a second user device associated with the second candidate linked entity identifier.

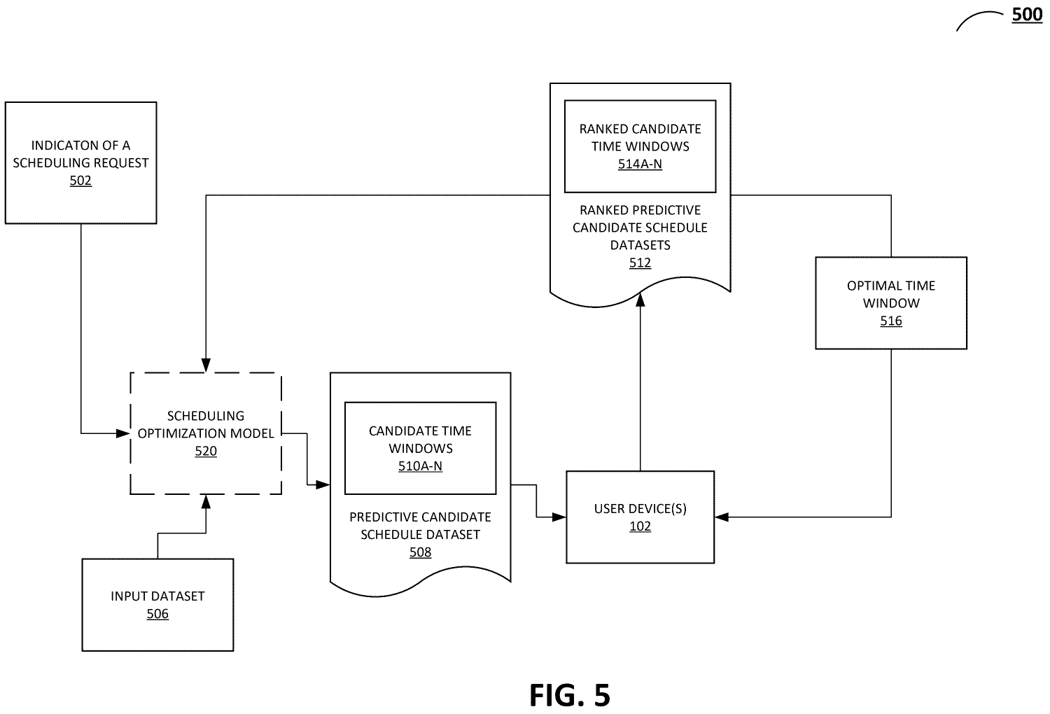

FIG. 5 provides a dataflow diagram 500 for a schedule optimization framework in accordance with some embodiments discussed herein. Specifically FIG. 5 provides a data flow diagram for a schedule optimization framework initiated based on a schedule request. In some embodiments, an indication of a schedule request 502 associated with a set of predictive entities. In some embodiments, a predictive entity may be an individual (e.g., a user) with respect to which one or more predictions tasks may be performed.

In some embodiments, the schedule request indication is any signals, data, instructions, and/or the like configured to trigger or otherwise initiate a scheduling optimization process. In some embodiments, a schedule request indication may originate from a user device. As an example, a scheduling request indication may be generated in response to a user input indicating a request to schedule a meeting for two or more users.

In some embodiments, a predictive candidate schedule dataset 508 is generated using a scheduling optimization model 520 and based on an input dataset 506. In some embodiments, the predictive candidate entity dataset 408 comprises one or more candidate time windows 510A-N. For example, the input dataset 506 may be applied to a scheduling optimization model 420 configured to analyze the input dataset 506 and output the predictive candidate schedule dataset 508 comprising the time windows. In some embodiments, a time window is a data entity that describes a data and a time range. For example, a time window may describe a date along with a first timestamp corresponding to a start time and a second timestamp corresponding to an end time on the corresponding date.

In some embodiments, the input dataset comprises a schedule associated with the set of predictive entities. For example, the system 101 may access an electronic calendar and/or the like associated with a predictive entity to retrieve the predictive entity's schedule. For example, the predictive entity may have previously given authorization to the system 101 to access the corresponding calendar, or the like associated with the predictive entity. The scheduling optimization model may be configured to analyze the schedule associated with each predictive entity in the set of predictive entities to identify one or more common open time widows for the set of predictive entities and generate a predictive candidate schedule dataset comprising the candidate time windows 510A-N.

In some embodiments, the predictive candidate schedule dataset 508 is provided to each of the predictive entities in the set of predictive entities via the user device 102 associated with the respective predictive entity. In some embodiments a request may be sent to the predictive entities along with the predictive candidate schedule dataset 508. The request may comprise a request for the predictive entities in the set of predictive entities to individually rank the candidate time windows 510A-N in the predictive candidate schedule dataset 508 based on their preferences. In response to receiving user inputs each comprising a ranked predictive candidate schedule dataset 512 for the predictive entity, an optimal time window 516 may be selected from the candidate time windows 510A-N based on the ranked predictive candidate schedule datasets 512 for the set of predictive entities. For example, the ranked predictive candidate schedule dataset 512 for a predictive entity may comprise individual ranked candidate time windows 514A-N for each predictive entity. In some embodiments, the scheduling optimization model 520 or other model may be leveraged to analyze the ranked predictive candidate schedule datasets 512 to select the optimal time window 516 for the set of predictive entities.

In some embodiments, data that includes the optimal time window is provided to the predictive entities in the set of predictive entities (e.g., via user device associated with the respective predictive entity).

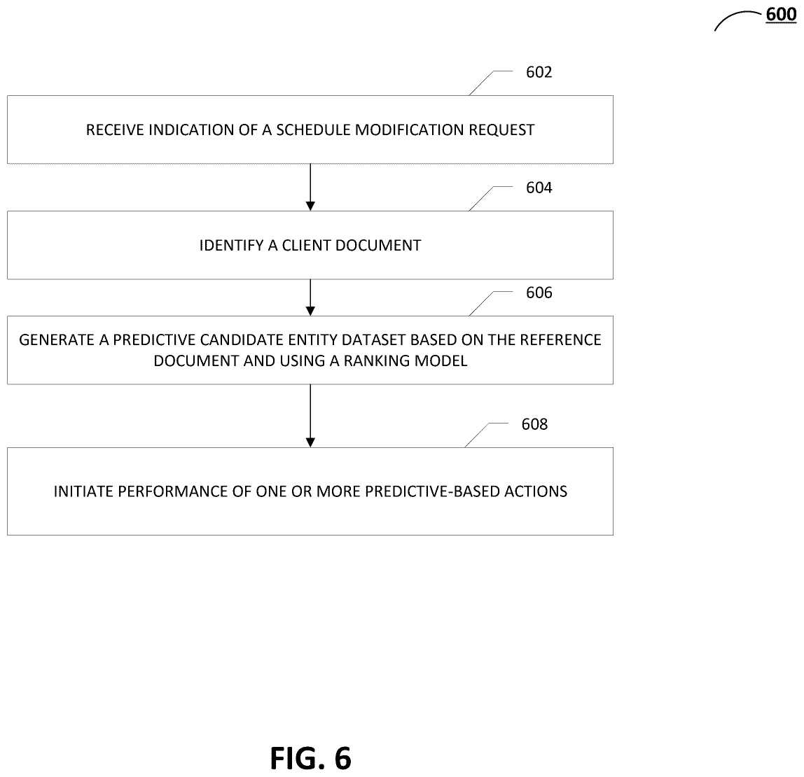

FIG. 6 is a flowchart diagram of an example process 600 for implementing a schedule optimization framework in accordance with some embodiments discussed herein. The process 600 may be implemented by one or more computing devices, entities, and/or systems described herein. FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving an indication of a schedule modification request. For example, the computing system 101 may receive an indication of a schedule modification request associated with a client entity.

In some embodiments, the process 600 includes, at step/operation 604, identifying a client document. For example, the computing system 101 may identify a client document comprising a plurality of linked entity identifiers.

In some embodiments, the process 600 includes, at step/operation 606, generating a predictive candidate entity dataset. For example, the computing system 101 may generate a predictive candidate entity dataset using a scheduling optimization model and based on the client document and input dataset corresponding to the client document. In some embodiments, the predictive candidate entity dataset comprises one or more ranked candidate linked entity identifiers from the plurality of linked entity identifiers and corresponding ranking. In some embodiments, the input dataset comprises current location data associated with one or more linked entity identifiers. For each of the one or more linked entity identifiers, the computing system 101 may receive the location data associated with the linked entity identifier via one or more location sensing devices. Alternatively or additionally, in some embodiments, the input dataset comprises availability data associated with one or more linked entity identifiers. In some embodiments, the scheduling optimization model is a machine learning model.

In some embodiments, the process 600 includes, at step/operation 608, initiating performance of one or more prediction-based actions. For example, the computing system 101 may initiate the performance of one or more prediction-based actions based on the predictive candidate entity dataset. In some embodiments, initiating the performance of one or more prediction-based actions comprises selecting a first candidate linked entity identifier from the predictive candidate entity dataset based on the corresponding ranking, generating a message data object based on the first linked entity identifier selected, and transmitting a message data object to a first user device associated with the first candidate linked entity identifier selected.

In some embodiments, an indication of an acceptance notification is received from the first user device and the client document is updated based on the acceptance notification. In some embodiments, an indication of a rejection notification is from the first user device. In response to receiving the indication of the rejection notification, the computing system 101 may select a second candidate linked entity identifier from the predictive candidate entity dataset based on the corresponding ranking and transmit a second message data object to a second user device associated with the second candidate linked entity identifier.

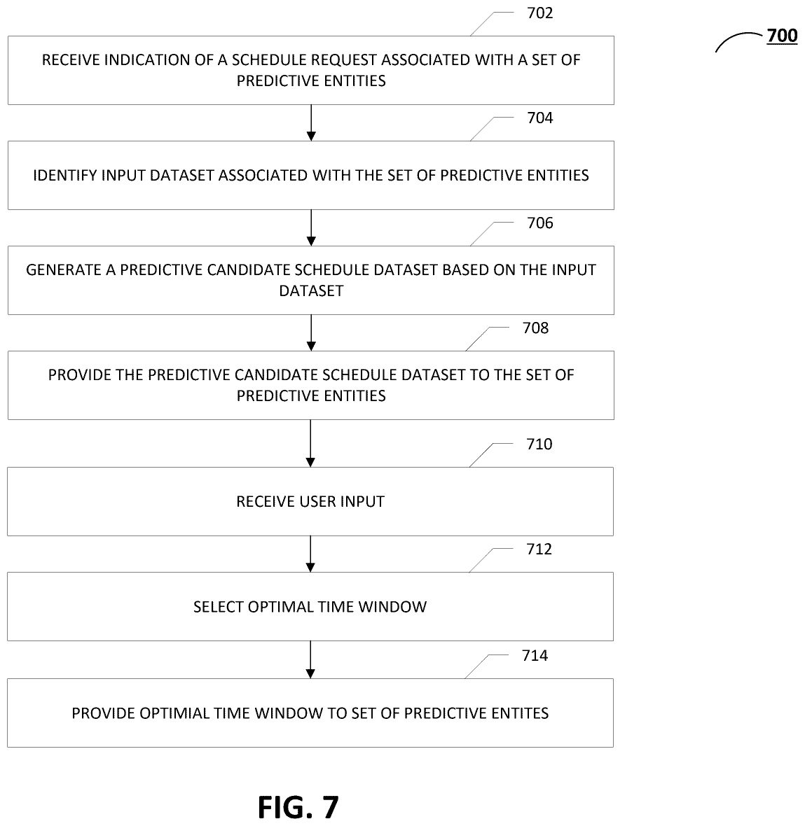

FIG. 7 is a flowchart diagram of an example process 700 for implementing a schedule optimization framework in accordance with some embodiments discussed herein. The process 700 may be implemented by one or more computing devices, entities, and/or systems described herein. FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702 receiving an indication of a schedule request. For example, the computing system 101 may receive an indication of a schedule request associated with a set of predictive entities.

In some embodiment, the process 700 includes, at step/operation 704 identifying an input dataset. For example, the computing system 101 may identify an input dataset associated with the set of predictive entities. In some embodiments, the input dataset comprises a schedule associated with the set of predictive entities. For example, the system 101 may access an electronic calendar and/or the like associated with a predictive entity to retrieve the predictive entity's schedule.

In some embodiments, the process 700 includes, at step/operation 706 generating a predictive candidate schedule dataset. For example, the computing system 101 may generate predictive candidate schedule dataset for the set of predictive entities using a scheduling optimization model and based on an input dataset. In some embodiments, the predictive candidate entity dataset comprises one or more candidate time windows.

In some embodiments, the process 700 includes, at step/operation 708, providing the predictive candidate schedule dataset to the set of predictive entities. For example, the computing system 101 may provide the predictive candidate schedule dataset to each of the predictive entities in the set of predictive entities via the user device 102 associated with the respective predictive entity. In some embodiments, the computing system 101 may send a request to the predictive entities along with the predictive candidate schedule dataset. The request may comprise a request for the predictive entities in the set of predictive entities to individually rank the candidate time windows in the predictive candidate schedule dataset based on their preferences.

In some embodiments, the process 700 includes, at step/operation 710 receiving user input. For example, the computing system 101 may receive user inputs from the client devices associated with the set of predictive entities, where each user input comprise a ranked predictive candidate schedule dataset for the corresponding predictive entity.

In some embodiments, the process 700 includes, at step/operation 712, selecting an optimal time window from the candidate time windows. For example, the computing system 101, in response to receiving the user inputs may select an optimal time window from the candidate time windows based on the ranked predictive candidate schedule datasets for the set of predictive entities. For example, the ranked predictive candidate schedule dataset 512 for a predictive entity may comprise individual ranked candidate time windows for each predictive entity. In some embodiments, a scheduling optimization model 520 or other model may be leveraged to analyze the ranked predictive candidate schedule datasets to select the optimal time window for the set of predictive entities.

In some embodiments, the process 700 includes at step/operation 714, providing data that includes the optimal time window. For example, the computing system 101 may provide data that includes the optimal time window to the predictive entities in the set of predictive entities via the user devices associated with the respective predictive entity.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving, by one or more processors, an indication of a schedule modification request associated with a client entity;
identifying, by the one or more processors, a client document comprising a plurality of linked entity identifiers;
generating, by the one or more processors and using a scheduling optimization model, a predictive candidate entity dataset based on the client document and input dataset corresponding to the client document, wherein the predictive candidate entity dataset comprises one or more ranked candidate linked entity identifiers from the plurality of linked entity identifiers and corresponding ranking; and
initiating performance of one or more prediction-based actions based on the predictive candidate entity dataset.

2. The computer-implemented method of claim 1, wherein initiating the performance of the one or more prediction-based actions comprises:
selecting a first candidate linked entity identifier from the predictive candidate entity dataset based on the corresponding ranking;
generating a message data object based on the first candidate linked entity identifier selected; and
transmitting the message data object to a first user device associated with the first candidate linked entity identifier selected.

3. The computer-implemented method of claim 2, further comprising:
receiving an indication of an acceptance notification from the first user device; and
updating the client document based on the acceptance notification.

4. The computer-implemented method of claim 2, further comprising:
receiving an indication of a rejection notification from the first user device;
selecting a second candidate linked entity identifier from the predictive candidate entity dataset based on the corresponding ranking; and
transmitting a second message data object to a second user device associated with the second candidate linked entity identifier.

5. The computer-implemented method of claim 1, wherein the input dataset comprises current location data associated with one or more linked entity identifiers.

6. The computer-implemented method of claim 5, further comprising:
for each of the one or more linked entity identifiers, receiving location data associated with the linked entity identifier via one or more location sensing devices.

7. The computer-implemented method of claim 1, wherein the input dataset comprises availability data associated with one or more linked entity identifiers.

8. The computer-implemented method of claim 1, wherein the scheduling optimization model is a machine learning model.

9. A computing system comprising memory and one or more processors communicatively coupled to the memory, the one or more processors configured to:
receive an indication of a schedule modification request associated with a client entity;
identify a client document comprising a plurality of linked entity identifiers;
generate, using a scheduling optimization model, a predictive candidate entity dataset based on the client document and input dataset corresponding to the client document, wherein the predictive candidate entity dataset comprises one or more ranked candidate linked entity identifiers from the plurality of linked entity identifiers and corresponding ranking; and
initiate performance of one or more prediction-based actions based on the predictive candidate entity dataset.

10. The computing system of claim 9, wherein the one or more processors are configured to initiate the performance of the one or more prediction-based actions by:
selecting a first candidate linked entity identifier from the predictive candidate entity dataset based on the corresponding ranking;
generating a message data object based on the first candidate linked entity identifier selected; and
transmitting the message data object to a first user device associated with the first candidate linked entity identifier selected.

11. The computing system of claim 10, wherein the one or more processors are further configured to:
receive an indication of an acceptance notification from the first user device; and
update the client document based on the acceptance notification.

12. The computing system of claim 10, wherein the one or more processors are further configured to:
receive an indication of a rejection notification from the first user device;
select a second candidate linked entity identifier from the predictive candidate entity dataset based on the corresponding ranking; and
transmit a second message data object to a second user device associated with the second candidate linked entity identifier.

13. The computing system of claim 9, wherein the input dataset comprises current location data associated with one or more linked entity identifiers.

14. The computing system of claim 13, wherein the one or more processors are further configured to:
for each of the one or more linked entity identifiers, receive location data associated with the linked entity identifier via one or more location sensing devices.

15. The computing system of claim 9, wherein the input dataset comprises availability data associated with one or more linked entity identifiers.

16. The computing system of claim 9, wherein the scheduling optimization model is a machine learning model.

17. A computer-implemented method comprising:
receiving, by one or more processors, an indication of a schedule request associated with a set of predictive entities;
generating, by the one or more processors, a predictive candidate schedule dataset based on an input dataset associated with the set of predictive entities, wherein the predictive candidate schedule dataset comprises candidate time windows;
providing, by the one or more processors, the predictive candidate schedule dataset to the set of predictive entities;
in response to receiving user inputs, selecting, by the one or more processors, an optimal time window from the candidate time windows based at least in part on the user inputs, wherein the user inputs comprises ranked predictive candidate schedule datasets; and
providing data including the optimal time window to user devices associated with the set of predictive entities.

18. The computer-implemented method of claim 17, further comprising identifying the input dataset.

19. The computer-implemented method of claim 17, wherein the input dataset comprises an electronic calendar associated with each predictive entity in the set of predictive entities.

20. The computer-implemented method of claim 17, wherein generating the predictive candidate schedule dataset comprises applying the input dataset to a scheduling optimization model.
